(19) United States
(12) Patent Application Publication
(10) Pub. No.: US 2017/0000113 A1
(43) Pub. Date: Jan. 5, 2017

(54) FUNGICIDAL BARK SPRAYS FOR TREES

(71) Applicant: Valent U.S.A., Corporation, Walnut Creek, CA (US)

(72) Inventor: BILLY R. CORBIN, JR., GREENVILLE, MS (US)

(21) Appl. No.: 15/198,574

(22) Filed: Jun. 30, 2016

Related U.S. Application Data
(60) Provisional application No. 62/188,272, filed on Jul. 2, 2015.

(51) Int. Cl. A01N 25/30; A01N 43/653

(52) U.S. Cl. CPC A01N 25/30; A01N 43/653

(57) ABSTRACT

The present invention generally relates to methods for controlling tree and vine fungal pathogens comprising spraying the bark of trees and vines with an effective amount of at least one inhibitor of succinate-dehydrogenase (“SDHI”) fungicide with an adjuvant

### FIELD OF THE INVENTION

The present invention generally relates to methods for controlling fungal infections comprising spraying the bark of trees or vines with an effective amount of at least one inhibitor of succinate-dehydrogenase (“SDHI”) and an adjuvant,

### BACKGROUND OF THE INVENTION

Fungal pathogens are a major problem for growers of trees and cause millions of dollars of damages each year in the United States. Fungal diseases cause significant crop yield losses each year because the infected fruit is not marketable. The diseases also cause damage to ornamental trees.

Currently, it is very difficult to control tree fungal pathogens for several reasons. First, some pathogens have developed resistance to commonly used fungicides. Secondly, some effective fungicides are being banned in some areas because they are harmful to the environment or humans.

Yet another issue is that often the currently available treatments have to be re-applied repeatedly to be effective and in order to treat secondary infections. Some treatments are applied up to 12 times in a growing season on apple trees. The extra applications add to the expense of the treatment because more of the product must be purchased, and significant time and labor resources are used during the subsequent applications. Further, each new application increases the risk of exposure of the product to non-target trees.

Another problem is that some treatments require that the leaves and fruit be treated. A lot of product must be used and the techniques are often dangerous and/or wasteful. Spray coverage is sometimes difficult to achieve and very important for good disease control of foliar and/or fruit diseases, For example, if a tree's leaves are infected, comprehensive treatment requires application of the product to the leaf surface, Given the size of trees, it is difficult to apply the product to the leaves, One application method requires the user to tediously spray the leaf and fruit surfaces with a low-pressure sprayer in close proximity. For a home owner or backyard gardener, this method may require the user to use a ladder or other tool to elevate himself to the leaves. The user must be careful not to damage the tree by climbing or other similar means of accessing the leaves. Alternatively, a high-pressure sprayer could be used, For this application method, the user could be on the ground, however, this method results in drift of the product to the surrounding area. The drift can require that people, animals, and non-target species be removed from the area of treatment or otherwise protected from the product by sufficient physical barriers. These additional measures required for safe and effective foliar spray applications are costly and inconvenient.

In the past, bark spray applications have been used with limited success. The treatments resulted in ineffective or unpredictable disease control in trees because the fungicides were not able to penetrate the tree bark and/or the tree could not transfer them to the areas in need of treatment.

Other means of treating trees are available but have proven to be ineffective or impractical to implement, Some methods require professionals who are trained in specialized equipment to apply the product. Other expensive methods include invasive drilling, bark injections, or high-pressure root flare injections. For example, there has been a fungicide that provided some systemic fungal protection, however, it was effective only when injected directly into the tree.

As their name suggests, SDHI fungicides inhibit succinate-dehydrogenase enzyme in the fungi. Specifically, they inhibit fungal respiration by blocking the ubiquinone-binding sites in the mitochondria' complex II. SDHIs were given activity group code number 7 by the Fungicide Resistance Action Committee (FRAC).

U.S. Pat. No. 8,580,836 discloses that carboxamide compounds can be sprayed on the bark of trees to control diseases. This patent, however, fails to disclose the use of SDHIs with an adjuvant as a bark spray in order to control tree fungal pathogens. Further, this patent fails to disclose the use of SDHIs with an adjuvant to control vine fungal pathogens.

Therefore, there is a need in the art for safe and effective methods for providing long-term and systemic protection to trees and vines from tree fungal pathogens.

### SUMMARY OF THE INVENTION

In one aspect, the present invention is directed to methods for controlling fungal pathogens comprising spraying the bark of trees with an effective amount of at least one SDHI fungicide and an adjuvant,

In another aspect, the present invention is directed to methods for controlling fungal pathogens comprising spraying the bark of vines with an effective amount of at least one SDHI fungicide and an adjuvant

### DETAILED DESCRIPTION OF THE INVENTION

Applicant expects that SDHI fungicides will provide systemic, broad spectrum disease control when applied as a bark spray to trees and vines. This finding will be especially useful to tree and vine growers because trees and vines have not been able to translocate other types of fungicides from their lower trunk bark to the leaves and fruit in the canopy.

Another advantage of this finding is that the trees and vines will be able to be sprayed when they are dormant. Frequently, tree and vine growers have more time and resources when the plants are dormant so the methods of the present invention will be especially convenient for growers.

Another anticipated advantage of the present invention is that the trees and vines may only need one treatment for systemic, all-season control.

Yet another predicted advantage of the present invention is that the trees can be treated by spraying only the base of their trunks. This method reduces waste and contact of the fungicides to non-target species in proximity to the trees.

In an embodiment, the present invention is directed to methods for controlling tree fungal infections comprising spraying the bark of trees with an effective amount of at least one SDHI fungicide and an adjuvant,

Suitable SDHI fungicides include penflufen, isopyrazam, bixafen, sedaxane, fluxapyroxad, benzovindiflupyr, fluopyram, penthiopyrad, boscalid, N-[1-(2,4-dichlohenyl)-1-methoxypropan-2-yl]-3-(difluoromethyl)-1-methyl-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichlormethylen)-1,2,3,4-tetrahydro-1,4-methanonaphthalen-5-yl]-3-(difluormethyl)-1-methyl-1H-pyrazol-4-carboxamide, and N-[(1R,4S)-9-(dichlormethylen)-1,2,3,4-tetrahydro-1,4-methanonaphthalen-5-yl]-3-(difluormethyl)-1-methyl-1H-pyrazol-4-carboxamide,

In another preferred embodiment, the effective amount of the SDHI fungicide is from about 0.0001 to about 1 gram per centimeter of tree trunk diameter at breast height. In a more preferred embodiment, the effective amount of the SDHI fungicide is from about 0.001 to about 0.01 grams per centimeter of trunk diameter at breast height. In a most preferred embodiment, the effective amount of the SDHI fungicide is from about 0.003 to about 0.03 grams per centimeter of trunk diameter at breast height.

In an embodiment, the adjuvant is selected from the group consisting of surfactants, emulsifiers, oils and salts. As used herein, “adjuvant” refers to an agriculturally acceptable spray adjuvant which enhances the effectiveness of the fungicide. In a preferred embodiment, the adjuvant is a surfactant.

In an embodiment, the adjuvant is from about 0.025 to about 10% volume per volume concentration in the spray solution. In a preferred embodiment, the adjuvant is from about 0.1 to about 5% volume per volume concentration. In a more preferred embodiment, the adjuvant is from about 1 to about 2.5% volume per volume concentration.

In an embodiment, the surfactant is from about 0.025 to about 10% volume per volume concentration in the spray solution. In a preferred embodiment, the surfactant is from about 0.1 to about 5% volume per volume concentration. In a more preferred embodiment, the surfactant is from about 1 to about 2.5% volume per volume concentration.

Suitable surfactants include, but are not limited to, mixtures of alkylphenol ethoxylate, polysiloxane polyether copolymers, and propylene glycol; polyether modified polysiloxanes; hexylene glycols; dipropylene glycols; ethoxylated alcohols; and combinations thereof. One presently preferred surfactant is a mixture of alkylphenol ethoxylate, polysiloxane polyether copolymers, and propylene glycol.

In a further embodiment, the tree is selected from the group consisting of apple, almond, pear, plum, apricot, peach, nectarine, cherry, coconut, palm, olive, fig, banana, cashew, walnut, pecan, persimmon, pomegranate, avocado, mango, papaya, pistachio, and citrus. In a preferred embodiment, the tree is selected from the group consisting of apple, almond, pear, plum, peach, nectarine, cherry, and pistachio.

In a preferred further embodiment, the apple tree variety or type is selected from the non-exclusive group consisting of crispin, braeburn, cameo, cortland, crabapple, empire, Fuji, gala, ginger gold, golden delicious, granny smith, honeycrisp, idared, jonagold, jonathan, McIntosh, mutsu, nittany, pink lady, rome, red delicious, stayman, winesap, and york.

In yet another embodiment, the tree is sprayed with an effective amount of the SDHI fungicide and adjuvant when the tree is dormant. As used herein, “dormant” refers to a period in the tree's life cycle when the tree has a significantly slowed metabolism. Leaves may or may not be present on the tree or vine at the time of application(s).

In an alternative embodiment, the tree is sprayed with an effective amount of the SDHI fungicide and adjuvant during the time between when the tree is dormant after leaf drop in the fall until the time when it produces leaf buds which typically occurs in the spring season of the year.

In yet another embodiment, the tree is sprayed with an effective amount of the SDHI fungicide and adjuvant during the time between When the tree is dormant until the time when bud swell begins in the spring of the year.

In embodiments of the present invention, the tree may be sprayed with high or low pressure (meaning lower than 40 psi) spraying mechanisms. A backpack sprayer or similar sprayer can be used for ease of the person delivering the spray to the tree bark.

In a further embodiment, the tree is sprayed on the lower 150 centimeters of the trunk. In a more preferred embodiment, the tree is sprayed on the lower 100 centimeters of the trunk.

In yet another embodiment, the SDHI fungicide may be mixed with a solvent prior to application. One presently preferred solvent is water.

In a preferred embodiment, the effective amount of SDHI fungicide is from about 10 to about 1000 parts per million active ingredient solution concentration. In a more preferred embodiment, the effective amount of SDHI fungicide is from about 25 to about 500 parts per million active ingredient solution concentration. In a most preferred embodiment, the effective amount of the SDHI fungicide is from about 50 to about 200 parts per million active ingredient solution concentration.

In an embodiment, the SDHI fungicide and the adjuvant may be mixed with another fungicide. In a preferred embodiment, the fungicide is a triazole fungicide. Two presently preferred triazole fungicides are metconazole and propiconazole.

In another preferred embodiment, the SDHI fungicide and the adjuvant may be mixed with a phosphonate. In a preferred embodiment, the phosphonate fungicide comprises mono and dipotassium salts of phosphorous acid (for example, Agri-Fos®, AgriFos is available from and a registered trademark of AgBio).

In an embodiment, the SDHI fungicide and the adjuvant may be mixed with an insecticide. One preferred class of insecticides is neonicotinoids. More preferably, the neonicotinoid is selected from the group consisting of clothianidin, imidacloprid, thiacloprid, dinotefuran, acetamiprid, nitenpyram and thiamethoxam.

In another embodiment, the SDHI fungicide and the adjuvant may be mixed with an insecticide. Another preferred class of insecticides is anthranilic diamides. More preferably, the anthranilic diamide is selected from the non-exclusive group consisting of chlorantraniliprole, cyantraniliprole, calteryx, and flubendiamine. Another insecticide that may be included is acephate that me be mixed with the SDHI fungicide and adjuvant.

In a further embodiment, the SDHI fungicide is mixed with a strobilurin fungicide. Preferably, the strobilurin is selected from the non-exclusive group consisting of azoxystrohin, tryifloxystrobin, fluoxastrobin, mandestrobin, picoxystrobin, pyraclostrobin, dimoxystrobin, metominostrobin and orysastrobin.

In yet another embodiment, the tree fungal pathogen is selected from the non-exclusive group consisting of apple scab (Venturia inaequalis), alternaria blotch (Alternaria mali), fabraea leaf spot (Fobraea spp.), bitter rot (Colletotrichum spp.), black rot (Botryosphaeria obtusa), black pox (Helminthosporium papulosum), brooks spot (Myeosphaerella pomi), cedar-apple rust (Gymnosporangium juniperi-virginianae), sooty blotch (Gloeodes pornigena, Peltaster fructicola, Geastrumia polystigmatus, Leptodontium elatus), fly speck (Zygophiala jarnaicensis), twig blight (Nectria cirmabarina), collar rot (Phytophthora eactorum), powdery mildew (Podo,sphaera leucotricha), quince rust (Gymnosporangium clavipes), southern blight (Sclerotium rolfsii), thread blight (Corticium stevensii), and white rot (Botryosphaeria dothidea). In a preferred embodiment, the pathogen is apple scab.

In another embodiment, the present invention. is directed to methods for controlling fungal pathogens comprising spraying the bark of a vine with an effective amount of a SDHI fungicide selected from the group consisting of penflufen, isopyrazam, bixafen, sedaxane, fluxapyroxad, fluopyram, penthiopyrad, boscalid, N-[1-(2,4-dichlohenyl)-1-methoxypropan-2-yl]-3-(difluoromethyl)-1-methyl-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichlormethylen)-1,2,3,4-tetrahydro-1,4-methanonaphthalen-5-yl]-3-(difluormethyl)-1-methyl-1H-pyrazol-4-carboxamide, and N-[(1R,4S)-9-(dichlormethylen)-1,2,3,4-tetrahydro-1,4-methanonaphthalen-5-yl]-3-(difluormethyl)-1-methyl-1H-pyrazol-4-carboxamide, and an adjuvant.

In a preferred embodiment, the adjuvant is a surfactant.

In another preferred embodiment, the vine is a grape vine.

As used herein, “yield” refers to an increase in the amount or number of fruit or nuts that are marketable.

As used herein, “controlling tree fungal pathogens” refers to reducing the amount of damage caused by the fungal pathogen(s) to a level that is acceptable to the grower. For example, “controlling tree fungal pathogens” can mean the prevention of the fungal infection, the treatment of an existing infection, limiting the spread of the infection, or the use of the methods as a prophylactic or preventative.

Throughout the application, the singular forms “a,” “an,” and “the” include plural reference unless the context clearly dictates otherwise.

As used herein, all numerical values relating to amounts, weight, percentages and the like, are defined as “about” or “approximately” each particular value, plus or minus 10%. For example, the phrase “at least 5.0% by weight” is to be understood as “at least 4.5% to 5.5% by weight” Therefore, amounts within 10% of the claimed values are encompassed by the scope of the claims.

The present invention is not limited to the particular embodiments and modes of operation described herein and it is possible to imagine a number of variations in the details without departing from the scope of this invention.

1. A method of controlling fungal pathogens comprising spraying the bark of a tree with an effective amount of a SDHI fungicide selected from the group consisting of penflufen, isopyrazam, bixafen, sedaxane, fluxapyroxad, fluopyram, penthiopyrad, boscalid, N-[1-(2,4-dichlohenyl)-1-methoxypropan-2-yl]-3-(difluoromethyl) -1-methyl-1H-pyrazole-4-carboxamide, N-[9-(dichloromethylene)-1,2,3,4-tetrahydro -1,4-methanonaphthalen-5-yl]-3-(difluoromethyl)-1-methyl-1H-pyrazole-4-carboxamide, N-[(1S,4R)-9-(dichlormethylen)-1,2,3,4-tetrahydro-1,4-methanonaphthalen-5-yl]-3-(difluorinethyl)-1-methyl-1H-pyrazol-4-carboxamide, and N-[1R,4S) -9-(dichlormethylen)-1,2,3,4-tetrahydro-1,4-methanonaphthalen-5-yl]-3 (difluormethyl)-1-methyl-1H-pyrazol-4-carboxamide, and an adjuvant.

2. The method of claim 1 wherein the adjuvant is a surfactant.

3. The method of claim 1 wherein the effective amount of SDHI fungicide is from about from about 0.0001 to about 1 gram per centimeter of the trunk diameter at breast height.

4. The method of claim 3 wherein the effective amount of SDHI fungicide is from about 0.001 to about 0.01 grams per centimeter of the trunk diameter at breast height.

5. The method of claim 1 wherein the tree is selected from the group consisting of apple, almond, pear, plum, apricot, peach, nectarine, cherry, coconut, palm, olive, fig, banana, cashew, walnut, pecan, persimmon, pomegranate, avocado, mango, papaya, pistachio, citrus.

6. The method of claim 1 wherein the tree is sprayed when the tree is dormant.

7. The method of claim 1 wherein the tree is sprayed on the lower 150 centimeters of the trunk.

8. The method of claim 1 wherein the SDHI fungicide is mixed with a solvent prior to application.

9. The method of claim 8 wherein the solvent is water,

10. The method of claim 8 wherein the concentration of the SDHI fungicide is from about 10 to about 1,000 parts per million active ingredient.

11. The method of claim 2 wherein the surfactant is a mixture of alkylphenol ethoxylate, polysiloxane polyether copolymers, and propylene glycol.

12. The method of claim 1 wherein the SDHI fungicide is mixed with a triazole fungicide.

13. The method of claim 12 wherein the triazole fungicide is metconazole.

14. The method of claim 1 wherein the SDHI fungicide is mixed with an insecticide.

15. The method of claim 14 wherein the insecticide is a neonicotinoid.

16. The method of claim 15 wherein the neonicotinoid is selected from the group consisting of clothianidin, imidacloprid, thiacloprid, dinotefuran, acetamiprid, nitenpyram and thiamethoxam.

17. The method of claim 1 wherein the SDHI fungicide is mixed with a strobilurin.

18. The method of claim 17 wherein the strobilurin is selected from the group consisting of azoxystrohin, tryifloxystrobin, fluoxastrobin, mandestrobin, picoxystrobin, pyraclostrobin, dimoxystrobin, metominostrobin and orysastrobin.

19. The method of claim 1 wherein the tree fungal pathogen is selected from the group consisting of apple scab (Venturia inaequalis), alternaria blotch (Alternaria mali), fabraea leaf spot (Fabraea spp.), bitter rot (Colletotrichum spp.), black rot (Botryosphaeria obtusa), black pox (Helminthosporium papuiosum), brooks spot (Mycosphaerella pomi), cedar-apple rust (Gymnosporangium juniperi-virginianae), sooty blotch (Gioeodes pomigena, Peltaster fructicola, Geastrumia polystigmatus, Leptodontium elatus), fly speck (Zygophiala jamaicensis), twig blight (Nectria cinnabarina), collar rot (Phytophthora cactorum), powdery mildew (Podasphaera Leucotricha), quince rust (Gymnosporangium clavipes), southern blight (Scierotium rolfsii), thread blight (Corticium stevensii), and white rot (Botryosphaeria dothidea).

20. A method of controlling fungal pathogens comprising spraying the bark of a vine with an effective amount of a SDHI fungicide selected from the group consisting of penflufen, isopyrazam, bixafen, sedaxane, fluxapyroxad, fluopyram, penthiopyrad, boscalid, N-[1-(2,4-dichlohenyl)-1-methoxypropan-2-yl]-3-(difluoromethyl)-1-methyl-1H-pyrazole-4-carboxamide, N-[9-(dichloromethylene)-1,2,3,4-tetrahydro- 1,4-methanonaphthalen-5-yl]-3-(difluoromethyl)-1-methyl-1H-pyrazole-4-carboxamide, N-[(1S,4R)-9-(dichlormethylen)-1,2,3,4-tetrahydro-1,4-methanonaphthalen-5-yl]-3-(difluormethyl)-1-methyl-1H-pyrazol-4-carboxamide, and N-[(1R,4S) -9-(dichlormethylen)-1,2,3,4-tetrahydro-1,4-methanonaphthalen-5-yl]-3-(difluormethyl) -1-methyl-1H-pyrazol-4-carboxamide, and an adjuvant.
